(19) United States
(12) Patent Application Publication
(10) Pub. No.: US 2026/0070076 A1
(43) Pub. Date: Mar. 12, 2026

(54) DISPENSING HEAD AND DISPENSER

(71) Applicant: APTAR DORTMUND GMBH, Dortmund (DE)

(72) Inventors: Bernhard JASPER, Dortmund (DE); Ralf JORDAN, Dortmund (DE)

(21) Appl. No.: 19/106,468

(22) PCT Filed: Sep. 21, 2023
(86) PCT No.: PCT/EP2023/076065

§ 371 Date: Feb. 25, 2025

(30) Foreign Application Priority Data
Sep. 23, 2022 (DE) 10 2022 124 560.8
Aug. 9, 2023 (DE) 10 2023 121 244.3

(51) Int. Cl. B05B 11/10

(52) U.S. Cl. CPC B05B 11/1047; B05B 11/1059

(57) ABSTRACT

A dispensing head for a dispenser for dispensing a fluid is proposed, wherein the dispensing head comprises a housing part and an actuator rotatable relative to the housing part for actuating the dispensing head or dispenser, and wherein the dispensing head, in particular the housing part, comprises a tamper-evident seal. According to a first aspect, the actuator and the tamper-evident seal are configured such that the actuator exerts a force on the tamper-evident seal when the actuator is first rotated relative to the housing part from a first rotational position to a second rotational position, in particular in the direction of rotation of the actuator and/or radially outwards, which causes the tamper-evident seal to be damaged and/or to fold down. According to a second aspect, the tamper-evident seal is formed integrally with the housing part.

The present invention relates to a dispensing head for dispensing a fluid according to the preamble of claim 1, and to a dispenser for dispensing a fluid comprising a dispensing head.

In particular, the present invention relates to a dispensing head for a dispenser for dispensing a fluid, the dispensing head having a tamper-evident seal. The fluid is preferably a cleaning product or a cosmetic product, for example a bath or glass cleaner, a shower gel, a shampoo, a cream, a perfume or the like.

In principle, it is also known in the prior art to provide a package or container for a product, in particular in the food and cosmetics sector, with a tamper-evident seal. A tamper-evident seal is in particular a device by means of which the user or consumer can recognize that the packaging or container is still in its original packaging or closed and has not yet been opened. For example, such a tamper-evident seal can be formed by a sticker that is attached in such a way that the sticker is damaged or destroyed when the packaging or container is opened (for the first time).

U.S. Pat. No. 3,848,778 A relates to a childproof actuator assembly, wherein an actuator button is mounted in a housing to form an actuator assembly which is secured to a valved aerosol or other container. The actuator button is rotatable between non-dispensing and dispensing positions. With the actuator button in the non-dispensing position, cooperable portions of the actuator assembly form a locking means to positively prevent rotational movement of the actuator button and, simultaneously, blocking means prevent operation of the dispensing valve. While the locking means is disabled by disengaging the cooperable portions, the actuator button is simultaneously rotated free of the blocking means into the dispensing position for dispensing product from the container by operation of the valve as by depressing or tilting the actuator button.

DE 199 42 791 A1 relates to a device to dispense media. The device consists of two one-piece housing parts for receiving a media blister. For tamper evidence and also to prevent unintentional actuation, a lock is provided for the rest position, which allows the housing parts to be separated and also to rotate relative to each other.

U.S. Pat. No. 4,796,770 A relates to an injection molded plastic closure having a tamper indicating portion. The tamper indicating portion includes a tampering indicating band which is attached to the skirt for radially outward hinging by a plurality of bridges. The tamper indicating band is subject to splitting whereby it may expand outwardly and clear a container neck finish. The tamper indicating band remains attached to the closure and the splitting thereof indicates tampering.

EP 4 008 442 A1 relates to a dispensing device for dispensing a fluid. The dispensing device has a conveying device for conveying the fluid from a container, which can be actuated by means of an actuating lever, the actuating lever being lockable against undesired actuation by means of a locking device. For unlocking, the actuating lever is preferably displaceably mounted. The dispensing device may additionally comprise a securing device which secures the actuating lever against unlocking by means of the locking device.

U.S. Pat. No. 4,324,351 A relates to a dispensing actuator which includes a button rotatable between a dispensing and nondispensing position, between two stops, the button having a tab engaging the stops, to avoid overriding the stop in the dispensing position, the tab has an inwardly extending lip which abuts against the stop.

US 2003/0150876 A1 relates to a product discharge assembly for a container of fluent material. A finger-operable pump cartridge is disposed within a closure for mounting the pump cartridge and closure to the container. An actuator is mounted on the pump cartridge. A shroud is mounted around the closure. The actuator has a skirt with a flange extending from, and continuously around, the skirt. The shroud has a lip for engaging the actuator flange to inhibit removal of the actuator from the stem if the actuator is moved outwardly relative to the stem beyond a predetermined position. The actuator and closure may also include cooperating interengageable features accommodating rotation of the actuator relative to the closure between an actuatable position permitting reciprocation of the actuator and a releasably locked position preventing reciprocation of the actuator.

It is an object of the present invention to provide a dispensing head with a tamper-evident seal, wherein the dispensing head is designed to be user-friendly, easy to operate and/or in which recycling is made possible in a simple manner.

The above object is solved by a dispensing head according to claim 1 or a dispenser according to claim 25. Advantageous further embodiments are the subject of the subclaims.

The present invention relates to a dispensing head for a dispenser for dispensing a fluid. The dispensing head comprises a housing part and an actuator rotatable relative to the housing part for actuating the dispensing head or dispenser. Furthermore, the dispensing head, in particular the housing part, has a tamper-evident seal.

According to a first aspect of the present invention, the actuator and the tamper-evident seal are configured such that when the actuator is for the first time rotated relative to the housing part from a first rotational position to a second rotational position, the actuator exerts a force on the tamper-evident seal that causes the tamper-evident seal to be damaged and/or actuated. In particular, the force exerted on the tamper-evident seal is a force directed in the direction of rotation of the actuator and/or radially outwards. In other words, the actuator preferably presses against the tamper-evident seal, in particular in the radial direction and/or in the direction of rotation of the actuator. On the one hand, this reliably achieves damage to the tamper-evident seal when the actuator is rotated for the first time, so that the tamper-evident seal reliably indicates when the dispensing head has already been used. Furthermore, this is conducive to easy and user-friendly operation of the dispensing head. In particular, no additional step is required to damage the tamper-evident seal, or damage to the tamper-evident seal advantageously occurs during a step required to actuate the dispensing head or during a movement of the actuator required to actuate the dispensing head.

According to another aspect of the present invention, which can also be implemented independently, the tamper-evident seal is integrally formed with the housing part. In other words, the tamper-evident seal constitutes a portion of the housing part. In particular, therefore, the tamper-evident seal is not formed as a separate or distinct part from the housing part. This is conducive to easy and/or inexpensive manufacture of the dispensing head, as well as easy and user-friendly operation.

The housing part or the dispensing head is preferably designed in such a way that the tamper-evident seal, in particular a main body of the tamper-evident seal, is formed integrally with the housing part or is connected to the housing part even after the damage and/or the actuation by the rotation of the actuator. In particular, the tamper-evident seal remains connected to the housing part or the tamper-evident seal is not separated from the dispensing head or housing part by the damage and/or actuation. This facilitates operation and separate disposal of a detached part is not required. Hereby, the dispensing head is also easier to recycle.

The tamper-evident seal preferably has at least one breakable connecting arm. In particular, the connecting arm is breakable by the (first) rotation of the actuator. The tamper-evident seal or its main body is connected to the housing part via the at least one connecting arm. In particular, the breakable connecting arm allows the tamper-evident seal to be damaged by the rotation of the actuator.

The tamper-evident seal preferably has a flexure bearing or an area of reduced material thickness. The tamper-evident seal or its main body is connected to the housing part via the flexure bearing or the area of reduced material thickness. On the one hand, this makes it possible to damage or actuate the tamper-evident seal when the actuator is rotated for the first time, in particular by the force directed in the direction of rotation of the actuator and/or radially outwards, and on the other hand it prevents the tamper-evident seal from being completely separated from the housing part. Further, the flexure bearing or the area of reduced material thickness allows the tamper-evident seal not to hinder the operation of the dispensing head, in particular a rotation of the actuator, after the initial rotation, even though the tamper-evident seal is not completely separated from the housing part.

Preferably, the tamper-evident seal is arranged, in particular completely, on an upper edge of the housing part. Further preferably, the tamper-evident seal projects inwards and/or downwards from an inner wall of the housing part. Through this, the tamper-evident seal preferably interacts with the actuator in a synergistic manner so that, by rotation of the actuator, the force directed in the direction of rotation of the actuator and/or radially outwards is exerted on the tamper-evident seal, which causes the damage and/or actuation, or the actuator presses against the tamper-evident seal accordingly. Furthermore, accidental damage to or actuation of the tamper-evident seal before the first rotation of the actuator is prevented.

The tamper-evident seal is preferably configured to be pivoted or folded outwards after the damage and/or actuation and/or the first rotation of the actuator. However, the tamper-evident seal can also be designed to be arranged inside the housing part and/or to pivoted or folded inwards and/or downwards after the damage and/or actuation and/or the first rotation of the actuator. This is in each case conducive to unhindered actuation and/or use of the dispensing head after the first rotation.

The dispensing head is preferably designed in such a way that the tamper-evident seal or its main body is moved, in particular pivoted or folded away, by the rotation of the actuator or its main body, in particular by at least substantially 90° and/or about an axis that is perpendicular to a central axis of the housing part or dispensing head and/or at least substantially radial. This is conducive to a reliable and easily recognizable indication of a successful actuation or first rotation, as well as an unhindered actuation or use of the dispensing head after the first rotation.

It is preferred that the dispensing head, in particular the housing part, has a fixing device for fixing the actuated and/or damaged tamper-evident seal, in particular the main body of the tamper-evident seal. The fixing device is preferably formed integrally with the housing part. By means of the fixing device, it can be prevented that the actuated and/or damaged tamper-evident seal breaks off and/or is in the way during use of the dispensing head or interferes with or impairs its function.

In particular, the fixing device is designed for automatic fixing of the tamper-evident seal. This is conducive to easy operation.

The fixing device is preferably designed for fixing of the tamper-evident seal or the main body of the tamper-evident seal by clamping. This enables simple and reliable fixing of the tamper-evident seal or main body.

Preferably, the fixing device is arranged on an inner side of the dispensing head or housing part. This is on the one hand aesthetically advantageous and on the other hand conducive to easy operation of the dispensing head.

The tamper-evident seal, in particular its main body, preferably has arms and/or a recess. The recess is preferably at least substantially V-shaped and/or formed be tween the arms. Particularly preferably, the fixing device is configured complementary to the arms and/or the recess and/or the arms and/or the recess is/are configured for fixing the tamper-evident seal or its main body. This enables (automatic) fixation of the tamper-evident seal in a simple and reliable manner.

The actuator preferably has a driver for exerting the force on the tamper-evident seal and/or for actuating and/or damaging the tamper-evident seal. In particular, the driver is designed to press against the tamper-evident seal when the actuator is rotated (for the first time) from the first rotational position to the second rotational position. This enables reliable and/or automatic actuation of or damage to the tamper-evident seal and thus reliable indication of use that has taken place.

Preferably, an actuation or axial movement of the actuator is blocked in the first rotational position and an actuation or axial movement of the actuator is enabled in the second rotational position. In other words, the actuator can preferably be blocked against actuation by a rotation into the first rotational position. This prevents accidental actuation or accidental leakage of the fluid. Furthermore, the tamper-evident seal acts synergistically with this locking function of the actuator: In the delivery state, the actuator is preferably in the first rotational position and is thus locked against actuation. To actuate the actuator, which is done in particular by an axial movement or a pressing down of the actuator, it is preferably necessary to rotate the actuator from the first rotational position to the second rotational position. In an advantageous manner, this (first) rotation damages the tamper-evident seal, so that the damage to the tamper-evident seal is caused by a step that is necessary anyway to actuate the actuator, or no additional step is required to put the dispensing head into an operational or dispensing-ready state.

The actuator is preferably rotationally asymmetrical about an axis of rotation, in particular the axis of rotation from the first to the second rotational position. Preferably, the actuator has a rotationally asymmetrical outer contour section. Particularly preferably, the outer contour section is circular arc-shaped in a first sector or angular range and straight in a second sector or angular range. This allows the tamper-evident seal to be damaged when the actuator is rotated for the first time.

The dispensing head is preferably at least partially arranged in the housing part and/or enclosed by the housing part. The housing part is preferably sleeve-like and/or put over the actuator.

According to another aspect, the present invention also relates to a dispenser for dispensing a fluid. The dispenser comprises a dispensing head configured as described herein.

The above aspects and features, as well as further aspects and features resulting from the claims and the following description, can be realized independently of each other and in various combinations.

Further advantages, features, characteristics and aspects of the present invention will be apparent from the claims and the following description of preferred embodiments with reference to the drawing. It shows:

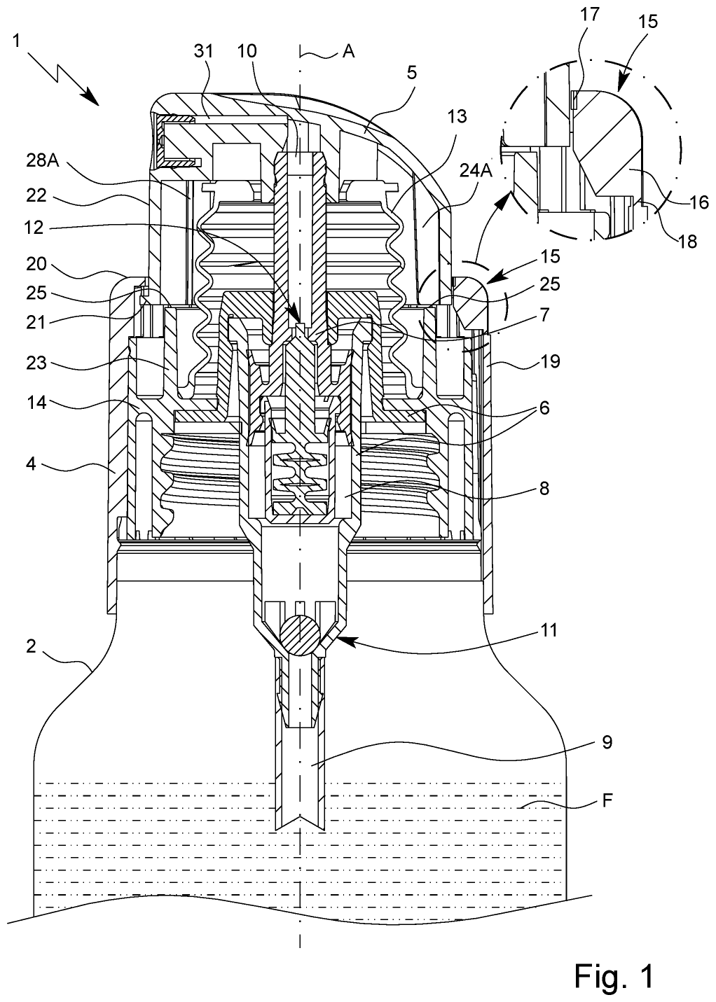

FIG. 1 a schematic section of a dispenser with a dispensing head according to the proposal;

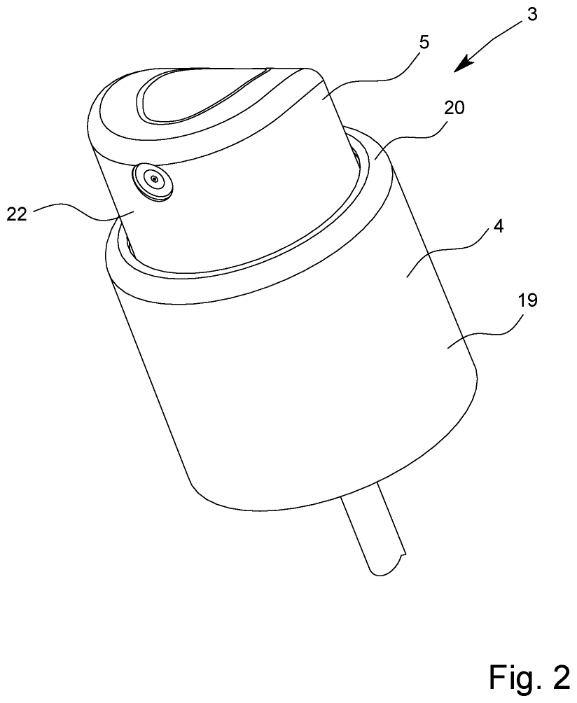

FIG. 2 a perspective view of a dispensing head according to the proposal;

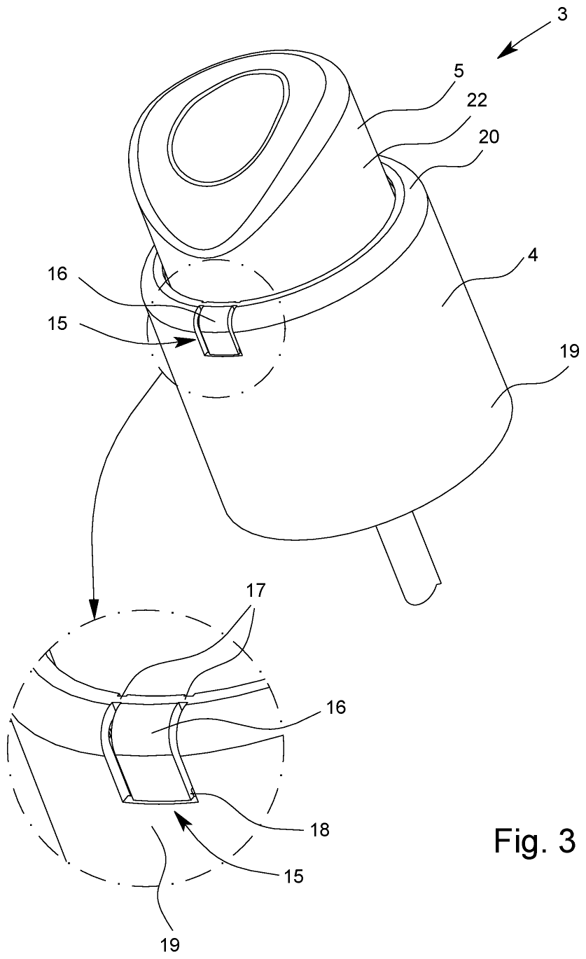

FIG. 3 a perspective view of the dispensing head with an undamaged or unactuated tamper-evident seal;

FIG. 4 a schematic perspective view of the dispensing head with damaged or activated tamper-evident seal;

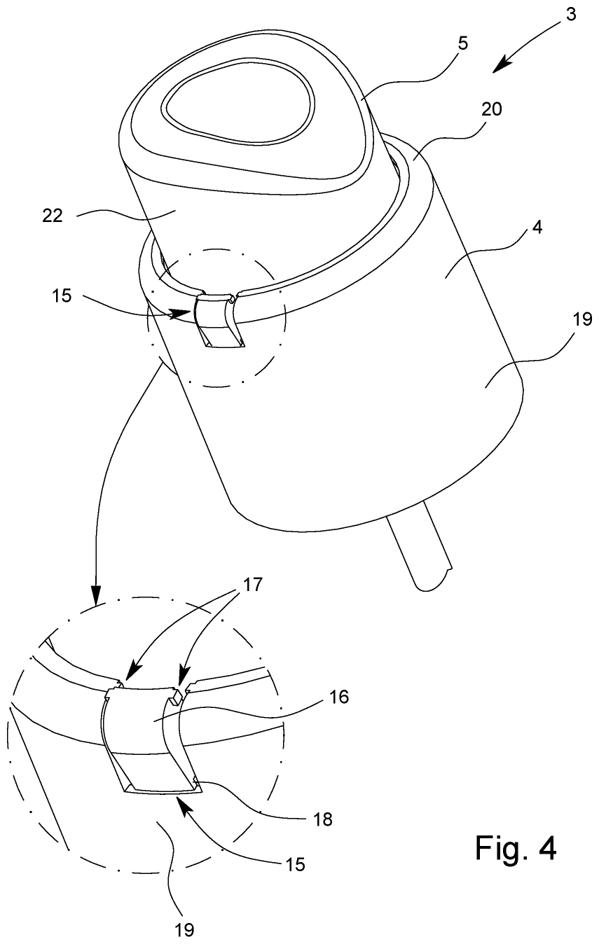

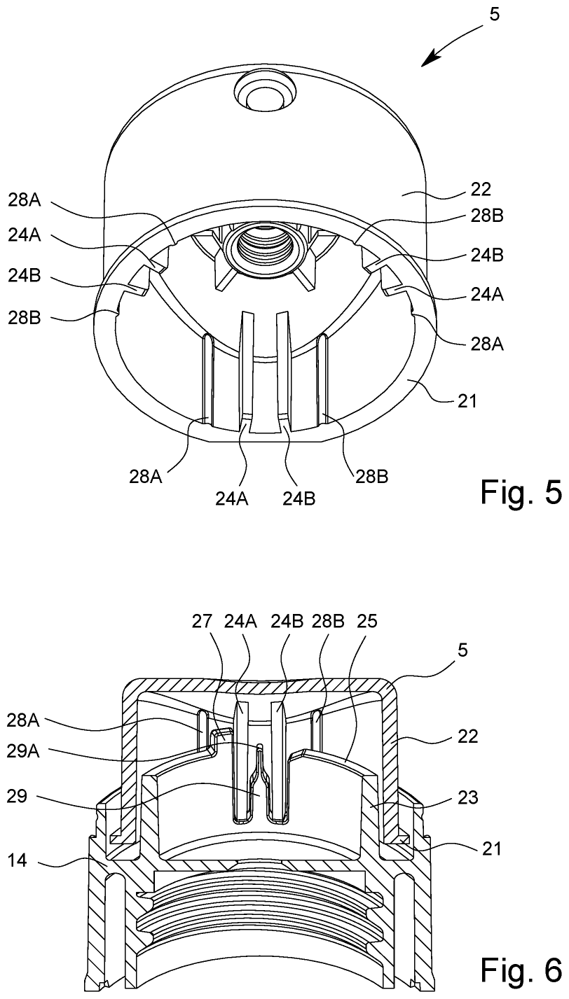

FIG. 5 a perspective view of an actuator;

FIG. 6 a schematic section through the actuator and a mounting part;

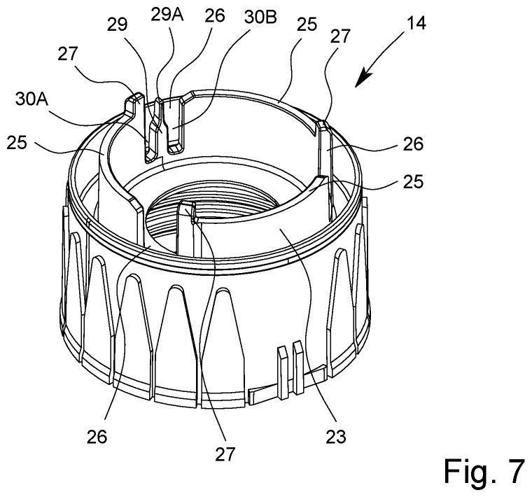

FIG. 7 a perspective view of the mounting part;

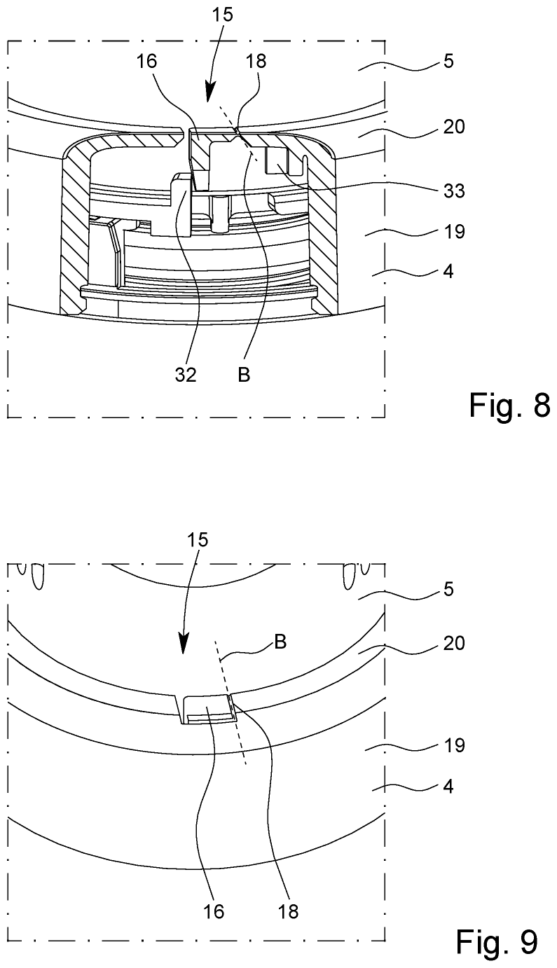

FIG. 8 a section of a perspective and partially cutaway view of the dispensing head with an undamaged or unactuated tamper-evident seal according to a second embodiment;

FIG. 9 a section of a perspective view of the dispensing head with an undamaged or unactuated tamper-evident seal according to the second embodiment;

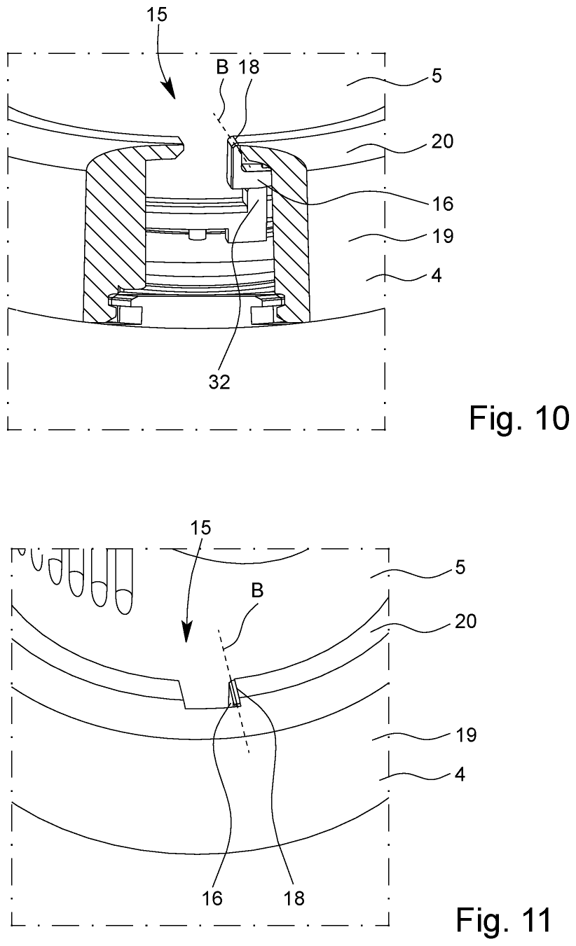

FIG. 10 a section of a perspective and partially cutaway view of the dispensing head with a damaged or actuated tamper-evident seal according to the second embodiment;

FIG. 11 a section of a perspective view of the dispensing head with a damaged or actuated tamper-evident seal according to the second embodiment; and

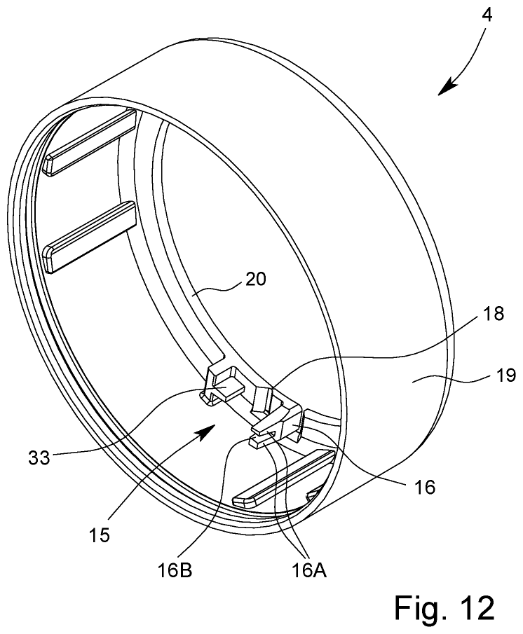

FIG. 12 a perspective view of a housing part according to the second embodiment.

In the Figures, some of which are not to scale and are only schematic, the same reference signs are used for the same or similar parts, whereby corresponding or comparable properties and advantages can be achieved even if a repeated description is omitted.

FIG. 1 shows a schematic view of a dispenser 1. The dispenser 1 has a container 2 for receiving a schematically indicated fluid F and a dispensing head 3 for dispensing the fluid F from the container 2.

The fluid F is preferably a cosmetic product, a medical product, a hygiene product, a cleaning product or the like, for example a deodorant, a perfume, a cream, a shaving foam, a shower gel, a shampoo, a hair gel, a hair spray, a bathroom cleaner, a dishwashing liquid, an oven cleaner or the like.

The fluid F is preferably contained in the dispenser 1 or container 2. Via the dispensing head 3, the fluid F can be conveyed from the container 2 and/or dispensed from the dispenser 1 and/or to a user not shown.

The dispensing head 3 has a housing part 4 and an actuator 5 rotatable relative to the housing part 4. The actuator 5 serves in particular to actuate the dispensing head 3 and/or dispenser 1. Actuation of the actuator 5 or dispensing head 3 or dispenser 1 takes place in particular by pressing down the actuator 5, as a result of which the fluid F is preferably conveyed out of the container 2 and dispensed by the dispensing head 3.

The dispensing head 3 and/or actuator 5 can be designed as a spray head and/or designed to dispense the fluid F in the form of a spray or aerosol. However, other solutions are also possible. For example, the dispensing head 3 and/or actuator 5 can be designed to dispense the fluid F in unchanged form or as a foam.

The housing part 4 is preferably formed as a sleeve, flange and/or collar. The housing part 4 is preferably slipped over the actuator 5.

The dispenser 1 and/or container 2 and/or dispensing head 3 preferably has a central or longitudinal axis A. The central or longitudinal axis A is referred to in the following as axis A for short. Designations such as “axial” and “radial” preferably refer to the axis A. Accordingly, an axial direction or extension is preferably a direction, extension or movement that is along the axis A or parallel to the axis A. Accordingly, a radial direction is a direction that is radial to the axis A.

Furthermore, relative designations or position designations such as “top”, “bottom” and the like refer to the position of the dispenser 1 or dispensing head 3 shown in FIG. 1.

The dispensing head 3 preferably has a pump with a pump housing 6, a piston 7, a pump chamber 8, an inlet 9, an outlet 10, an inlet valve 11 and an outlet valve 12.

The outlet valve 12 preferably includes a valve stem 12A and a valve spring 12B for closing the outlet valve 12 and/or biasing the valve stem 12A into a closed position of the outlet valve 12. Preferably, the valve spring 12B is integrally formed with the valve stem 12A. Preferably, the valve stem 12A and/or the valve spring 12B are made of the same material and/or of plastic.

With the pump, a fluid F can be conveyed from the container 2 of the dispenser 1 and dispensed via the dispensing head 3. The piston 7 is axially movable to convey the fluid F via the inlet 9 into the pump chamber 8 and from the pump chamber 8 to the outlet 10.

The pump is preferably arranged within the housing part 4 and/or enclosed by the housing part 4.

The dispensing head 3 preferably has a return device 13, in particular a return spring, for biasing and/or returning the piston 7 and/or the actuator 5 to an initial position. In the illustration example, the return device 13 is designed as a spring bellows and/or is made of plastic. However, other solutions are also possible here, for example a return device 13 designed as a metal and/or spiral spring.

The actuator 5 is preferably attached to the piston 7, in particular in such a way that the piston 7 and the actuator 5 move axially together, in particular when the actuator 5 is actuated or pressed down in the direction of the container 2 starting from the initial position shown in FIG. 1 and/or is moved back to the initial position, in particular by means of the return device 13.

The dispensing head 3 preferably has a mounting part 14. The mounting part 14 is preferably arranged inside the housing part 4 and/or enclosed by the housing part 4.

The mounting part 14 preferably is or can be mounted to the container 2, in particular to an upper edge of the container 2, for example screwed onto the container 2.

Preferably, the pump or pump housing 6 is attached to and/or held by the mounting part 14.

The return device 13 is preferably supported on the mounting part 14 and/or arranged between the actuator 5 and the mounting part 14.

Preferably, the housing part 4 is non-rotatably connected to the mounting part 14.

The dispensing head 3, in particular the housing part 4, has a tamper-evident seal 15.

The tamper-evident seal 15 is preferably designed to indicate or signal an original state of the dispensing head 3 or dispenser 1. In particular, the tamper-evident seal 15 is designed to signal or indicate to a user when the dispensing head 3 or dispenser 1 has already been used. This is done in particular by the tamper-evident seal 15 being actuated and/or damaged when the dispensing head 3 is (necessarily) used for the first time.

FIG. 2 shows the dispensing head 3 in a perspective view, in particular from a front side. In FIGS. 3 and 4, the dispensing head 3 is also shown in a perspective view, but here in particular as seen from a rear side.

The tamper-evident seal 15 is shown in particular in FIGS. 1, 3 and 4.

The tamper-evident seal 15 is preferably configured to be actuated and/or damaged by a (first) rotation of the actuator 5, in particular about the axis A and/or relative to the housing part 4.

In the present invention, an “actuation” of the tamper-evident seal 15 is understood in particular as an action on the tamper-evident seal 15 by which the tamper-evident seal 15 moves, in particular pivots and/or folds down, and/or by which the tamper-evident seal 15 is damaged. An actuation of the tamper-evident seal 15 occurs in particular automatically and/or by means of the actuator 5. In particular, an actuation of the tamper-evident seal 15 is a pressing against the tamper-evident seal 15, particularly preferably by means of the actuator 5.

In particular, an undamaged or unactuated state of the tamper-evident seal 15 indicates or signals to a user that the dispensing head 3 or actuator 5 has not yet been actuated or used. An actuated or damaged tamper-evident seal 15 indicates or signals to a user that the dispensing head 3 or dispenser 1 is no longer in its original or delivery state or that it has already been used/actuated.

The actuator 5 can preferably be positioned or arranged in different rotational positions, in particular a first rotational position and a second rotational position different from the first rotational position, relative to the axis A or to the housing part 4 or can be rotated between the first rotational position and the second rotational position. The axis A represents in particular an axis of rotation of the actuator 5 or of the rotation from the first rotational position into the second rotational position.

In FIG. 3 the actuator 5 is shown in the first rotational position and in FIG. 4 the actuator 5 is shown in the second rotational position. Preferably, there is a rotation angle of about 90° around the axis A between the first rotational position and the second rotational position.

The actuator 5 is preferably rotatable relative to the housing part 4, in particular about the axis A.

Preferably, —at least in the second rotational position—the actuator 5 is axially movable relative to the axis A and/or the housing part 4. Particularly preferably, an actuation and/or axial movement of the actuator 5 is blocked in the first rotational position and an actuation and/or axial movement of the actuator 5 is enabled in the second rotational position. In other words, the actuator 5 is thus preferably blockable against an actuation and/or axial movement, in particular an axial pushing down in the direction of the container 2. This will be discussed in more detail later.

In FIG. 3, the tamper-evident seal 15 is shown in a delivery and/or original state and/or in an undamaged and/or unactuated state. In FIG. 4, the tamper-evident seal 15 is shown in a damaged and/or actuated state.

The tamper-evident seal 15 is preferably configured to be actuated and/or damaged prior to or during a first actuation of the actuator 5 and/or dispensing head 3 and/or dispenser 1.

Preferably, the tamper-evident seal 15 is formed integrally or in one piece with the housing part 4. In particular, the tamper-evident seal 15 forms a section or portion of the housing part 4. Preferably, the tamper-evident seal 15 is firmly or inseparably connected to the housing part 4.

In other words, the housing part 4 preferably has two sections or the housing part 4 comprises two sections, namely the tamper-evident seal 15 and a section surrounding the tamper-evident seal 15.

The tamper-evident seal 15 is preferably made of the same material as the housing part 4. In particular, the housing part 4 and/or the tamper-evident seal 15 are made of plastic.

The tamper-evident seal 15 is preferably injection molded together with the housing part 4.

The tamper-evident seal 15 preferably has a main body 16.

The tamper-evident seal 15 preferably has at least one connecting arm 17. The tamper-evident seal 15 and/or the main body 16 is preferably connected to the housing part 4 via the connecting arm 17. In particular, the connecting arm 17 is formed integrally or in one piece with the tamper-evident seal 15 and/or main body 16 and the housing part 4. In particular, the connecting arm 17 is breakable by a rotation or the first rotation of the actuator 5 relative to the tamper-evident seal 15 and/or housing part 4, in particular from the first rotational position into the second rotational position, or is designed to be broken through during the first rotation of the actuator 5 from the first rotational position into the second rotational position.

The connecting arm 17 preferably projects from the main body 16 in the circumferential direction and/or tangentially, in particular relative to the axis A. Preferably, the connecting arm 17 is arranged at the top of the main body 16.

In the illustrative example, the tamper-evident seal 15 has two connecting arms 17, in particular wherein the two connecting arms 17 of the tamper-evident seal 15 are designed identically. The explanations regarding the at least one connecting arm 17 therefore preferably apply to both connecting arms 17.

The tamper-evident seal 15 preferably has a flexure bearing 18. The flexure bearing 18 is preferably designed as a living hinge. The tamper-evident seal 15 and/or the main body 16 is preferably connected to the housing part 4 via the flexure bearing 18. The main body 16 is preferably pivotable about the flexure bearing 18. The pivot axis preferably runs at least substantially perpendicular to the axis A.

In particular, the tamper-evident seal 15 has a portion of reduced material thickness and/or the flexure bearing 18 is formed by a portion of reduced material thickness.

The flexure bearing 18 is preferably formed by a continuation of an at least substantially (hollow) cylindrical wall section 19 of the housing part 4. The material thickness of the flexure bearing 18 is preferably reduced compared to the material thickness of the wall section 19 and/or of the main body 16, in particular in the radial direction. In other words, the thickness or material thickness of the flexure bearing 18 is preferably less than the thickness or material thickness of the wall section 19 and/or of the main body 16, in particular measured radially to the axis A. This can be seen in particular in FIG. 1.

The flexure bearing 18 is preferably arranged at the bottom or on the side facing the container 2 on the main body 16.

The main body 16 is preferably connected to the housing part 4 or integrally formed with the housing part 4 by means of the connecting arms 17 and/or the flexure bearing 18. In particular, the main body 16 is held to the housing part 4 by the connecting arms 17 and/or the flexure bearing 18.

The dispensing head 3 and/or the tamper-evident seal 15 is preferably designed so that the tamper-evident seal 15 and/or the main body 16 is folded or pivoted outwards from the housing part 4 after the tamper-evident seal 15 has been actuated and/or damaged, in particular after the connecting arm(s) 17 has (have) been broken or after the actuator 5 has been rotated for the first time. This is made possible in particular by the flexure bearing 18 or a pivoting of the main body 16 about the flexure bearing 18.

The connecting arms 17 and the flexure bearing 18 are preferably designed or matched to each other in such a way that, when the actuator 5 is rotated (for the first time) from the first to the second rotational position, the connecting arms 17 break through, thus damaging the tamper-evident seal 15, and at the same time the flexure bearing 18 remains intact and allows the tamper-evident seal 15 or main body 16 to move, in particular outwards.

The housing part 4 preferably has a wall section 19 and/or an (upper) edge 20.

The wall section 19 is preferably at least substantially cylindrical or hollow cylindrical in shape. The wall section 19 preferably has or forms an outer surface 22 in the form of a cylindrical surface.

The edge 20 is preferably arranged on an upper side and/or side facing away from the container 2 of the housing part 4 and/or wall section 19.

Preferably, the edge 20 projects radially inwards and/or in the direction of the axis A from the wall section 19, in particular so that a collar and/or stop for the actuator 5 is formed by the edge 20.

The tamper-evident seal 15 is preferably arranged at an upper end, and/or end facing away from the container 2, of the cylindrical wall section 19 and/or at the edge 20 or in the vicinity of the edge 20.

Preferably, the tamper-evident seal 15 and/or the main body 16 is connected to the wall section 19 by means of the flexure bearing 18 and/or connected to the edge 20 by means of the connecting arms 17.

The main body 16 is preferably connected to the wall section 19 on its bottom side via the flexure bearing 18 and is separated from the wall section 19 and/or edge 20 in the lateral direction or circumferential direction about the axis of rotation A, in particular by slots or slot-like openings. Preferably, the connecting arms 17 bridge the slots.

The tamper-evident seal 15 and/or the main body 16 preferably protrudes inwards and/or radially and/or in the direction of the axis A from the housing part 4 and/or the wall section 19, in particular an inner wall of the housing part 4 or wall section 19.

FIG. 5 shows a perspective view of the actuator 5. In particular, the inside of the actuator 5 is shown or recognizable in FIG. 5.

The actuator 5 is preferably rotationally asymmetrical, in particular about the axis A. Preferably, the actuator 5 has a rotationally asymmetrical outer contour section 21, in particular radially to the axis A or axis of rotation.

The actuator 5 preferably has a cylindrical outer surface 22. The axis A is preferably a symmetry or longitudinal axis of the cylindrical outer surface 22.

The outer contour section 21 is preferably arranged at a lower end, or an end facing the container 2, of the actuator 5 and/or the outer surface 22.

In particular, the outer contour section 21 projects radially outwards from the outer surface 22.

The outer contour section 21 forms in particular an (outer) edge or stop. The outer contour section 21 is in particular assigned to the edge 20 of the housing part 4 and/or engages behind the edge 20 of the housing part 4.

Preferably, the outer contour section 21 runs in the shape of a circular arc in a first sector or angular range around the axis A or axis of rotation and in a second sector or angular range around the axis A or axis of rotation it runs straight, in particular tangentially or perpendicularly to the axis A. However, other solutions are also possible in principle, for example an oval, elliptical or polygonal outer contour section 21.

In other words, the outer contour section 21 is preferably at least substantially in the shape of a circle, which is flattened or has a flattening in an area, in particular sector or angular area.

The dispensing head 3 or the actuator 5 and the tamper-evident seal 15 is/are preferably designed in such a way that the tamper-evident seal 15 can be actuated and/or damaged or is actuated and/or damaged by a (first) rotation of the actuator 5 from the first rotational position to the second rotational position. In particular, the dispensing head 3 or the actuator 5 and the tamper-evident seal 15 is/are designed in such a way that the actuator 5 contacts the tamper-evident seal 15 or the main body 16 and/or exerts a force, in particular directed radially outwards, on the tamper-evident seal 15 or the main body 16 or presses (radially) against the tamper-evident seal 15 or the main body 16, respectively, during a first rotation relative to the housing part 4 from the first rotational position into the second rotational position. The force exerted on the tamper-evident seal 15 or the main body 16 in particular causes the tamper-evident seal 15 to be actuated and/or damaged, particularly preferably causing the connecting arm(s) 17 to break.

In other words, the tamper-evident seal 15 is preferably adapted to be actuated and/or damaged upon initial rotation of the actuator 5.

Further, the housing part 4 is preferably configured such that the tamper-evident seal 15 remains to be integral or in one piece with the housing part 4 even after the actuator 5 has been actuated or damaged or the connecting arms 17 have been broken by the (first) rotation of the actuator 5. In other words, the housing part 4 or the dispensing head 3 is preferably configured such that the tamper-evident seal 15 or the main body 16 continues to be connected to the housing part 4 after the (first) rotation of the actuator 5, in particular via the flexure bearing 18.

Preferably, then, the dispensing head 3 is configured such that when the actuator 5 is rotated for the first time from the first rotational position to the second rotational position, the connecting arm(s) 17 is/are broken so that the tamper-evident seal 15 is damaged, but the solid-state joint 18 is not damaged or remains intact and the tamper-evident seal 15 remains connected to the housing part 4 via the flexure bearing 18 even after the connecting arms 17 are broken or damaged.

It is thus preferably prevented that the tamper-evident seal 15 is completely separated from the housing part 4. This facilitates operation and makes the dispensing head 3 user-friendly, in particular because no separated part has to be disposed of separately.

Preferably, during the rotation of the actuator 5, the force exerted on the tamper-evident seal 15 is caused by the rotational asymmetry of the actuator 5. In particular, the actuator 5 or outer contour section 21 is rotationally asymmetrical in such a way that, when the actuator 5 is rotated about the axis of rotation, the distance of the outer edge or outer contour section 21 of the actuator 5 lying in the direction of the tamper-evident seal 15 from the axis of rotation increases and/or the distance to the tamper-evident seal 15 and/or main body 16 decreases, so that the actuator 5 or outer contour section 21 slides along the tamper-evident seal 15 or its main body 16 and presses the main body 16 outwards. The force exerted by this finally causes the connecting arms 17 to break and/or the tamper-evident seal 15 to fold down or pivot outwards, in particular via the flexure bearing 18.

In the first rotational position of the actuator 5, the distance of the outer contour section 21 or its edge from the axis of rotation in the direction of the tamper-evident seal 15 is preferably minimal and/or smaller than in at least one other rotational position.

Particularly preferably, in the first rotational position, the sector or angular region in which the outer contour section 21 runs straight or tangential to the axis A is oriented towards the tamper-evident seal 15. The rotation of the actuator 5 from the first to the second rotational position then causes the arcuate sector or angular region to come into contact with the tamper-evident seal 15. Since the outer edge of the arcuate sector or angular region is at a greater distance from the axis A than the straight sector, this presses the tamper-evident seal 15 or the main body 16 outwards.

Preferably, the dispensing head 3 is designed in such a way that an axial movement of the actuator 5 downwards or in the direction of the pump or the container 2 is blocked in the first rotational position and unblocked in the second rotational position. In other words, an actuation of the actuator 5, in particular for the dispensing of fluid, is blocked in the first rotational position and enabled in a second rotational position.

The dispensing head 3 can therefore be locked by rotating the actuator 5 to the first rotational position and/or has a twist-to-lock function.

Preferably, the twist-to-lock function is implemented basically as described in US 2003/0150876 A1. This function is therefore only briefly explained below and reference is otherwise made to US 2003/0150876 A1.

The functionality of the twist-to-lock function can be seen in particular in FIGS. 6 and 7. FIG. 6 shows a sectional view of the actuator 5 and the mounting part 14. FIG. 7 shows a perspective view of the mounting part 14.

Furthermore, FIG. 6 shows the actuator 5 in the second rotational position, wherein the actuator 5 has additionally been moved axially downwards from the position shown in FIG. 1.

Preferably, the dispensing head 3, in particular the mounting part 14, has a blocking device 23 for blocking an axial movement of the actuator 5 in the first rotational position and/or outside the second rotational position. The blocking device 23 is preferably at least substantially cylindrical or cylinder-jacket-shaped.

Preferably, the actuator 5 has at least one, preferably a plurality of ribs 24A, 24B, which in particular are assigned to the blocking device 23 and/or are in operative connection with the blocking device 23. The ribs 24A, 24B are preferably arranged on an inner side of the actuator 5, in particular the inner side of the wall section of the actuator 5 forming or comprising the outer surface 22.

The ribs 24A, 24B, in particular the pairs of ribs, preferably represent reinforcements and/or struts of the actuator 5. Preferably, the ribs 24A, 24B prevent or reduce deformation of the actuator 5, in particular during rotation.

Preferably, the ribs 24A, 24B are elongated and/or the ribs 24A, 24B extend parallel to the axis A.

In particular, the actuator 5 has multiple pairs of ribs 24A, 24B and/or the ribs 24A, 24B are arranged in pairs in the actuator 5. In the illustrative example, the actuator 5 has three pairs of ribs 24A, 24B, for a total of six ribs 24A, 24B. The three pairs of ribs 24A, 24B are preferably arranged symmetrically and/or each offset from one another by about 120° about the axis A.

Each pair preferably has a first rib 24A and a second rib 24B. The two ribs 24A, 24B of a pair preferably have a smaller distance to each other than to other ribs 24A, 24B or to ribs 24A, 24B of other pairs.

The ribs 24A, 24B are preferably identical in shape.

The blocking device 23 preferably has a blocking surface 25. The blocking surface 25 preferably forms or has an upper edge of the blocking device 23.

The blocking surface 25 preferably cooperates with the ribs 24A, 24B. In particular, the ribs 24A, 24B and the blocking surface 25 are configured in such a way that in the first rotational position, the ribs 24A, 24B abut or rest on the blocking surface 25 and/or an axial movement of the actuator 5 in the direction of the blocking device 23 or blocking surface 25 is prevented, in particular by the ribs 24A, 24B contacting the blocking surface 25 during a downward movement of the actuator 5 or a movement of the actuator 5 in the direction of the container 2.

The blocking surface 25 is preferably interrupted and/or has several, in the illustrative example three, sections separated from each other, which preferably lie in the same plane. Preferably, each of the sections is assigned to a pair of ribs.

Further, the blocking device 23 has at least one recess 26. The recess 26 is formed to receive a rib 24A, 24B, preferably a pair of ribs 24A, 24B. In the recess 26, the upper edge of the blocking device 23 is lowered downwards relative to the blocking surface 25. In particular, the recess 26 allows the actuator 5 to move axially downwards when the actuator 5 is in the second rotational position.

In the illustrated example, the blocking device 23 has three recesses 26. The recesses 26 are preferably arranged symmetrically and/or each offset from the other by about 120° about the axis A. Preferably, each of the recesses 26 is assigned to a pair of ribs.

The blocking device 23 preferably has at least one stop 27.

In the illustrated example, the blocking device 23 has three stops 27. The stops 27 are preferably arranged symmetrically and/or offset from each other by approximately 120° about the axis A.

In particular, the stops 27 define or determine the first and second rotational positions, in particular together with the ribs 24A, 24B. Preferably, the stops 27 project upwards from the blocking surface 25.

In the first rotational position, the ribs 24A, 24B preferably rest on the blocking surface 25 and/or the blocking surface 25, together with the ribs 24, prevents an axial downward movement of the actuator 5. Furthermore, the stops 27 preferably block a rotation of the actuator 5 starting from the first rotational position in a direction opposite to the second rotational position. From the first rotational position, the actuator 5 is therefore preferably rotatable only in the direction of the second rotational position, while a rotation in the opposite direction is prevented by the stops 27, in particular by the ribs 24A, 24B contacting the stops 27.

When the actuator 5 is rotated in the direction of the second rotational position and/or reaches the second rotational position, the ribs 24 are located above the recesses 26, so that in the second rotational position the actuator 5 can be moved downwards. In particular, when the actuator 5 moves downwards, the ribs 24A, 24B move into the recesses 26. Preferably, one of the pairs of ribs 24A, 24B moves into each of the recesses 26. A rotation beyond the second rotational position and/or starting from the second rotational position in the direction of rotation from the first rotational position into the second rotational position is preferably prevented by the stops 27, in particular by the ribs 24A, 24B contacting the stops 27.

Each pair of ribs 24A, 24B is preferably arranged between two stops 27.

Preferably, a rotation of the actuator 5 in the direction of rotation from the first rotational position into the second rotational position beyond the second rotational position is prevented by a contact of the second ribs 24B of a pair of ribs with a stop 27 in each case. A rotation of the actuator 5 in the direction from the second rotational position into the first rotational position beyond the first rotational position is preferably prevented by a contact of the first ribs 24A of a pair of ribs with a stop 27 in each case.

The ribs 24A, 24B, the recesses 26 and/or the stops 27 are preferably designed and/or arranged in such a way that when the actuator 5 rotates from the first rotational position to the second rotational position, an angle of rotation of approximately 90° is swept over and/or the first and second rotational positions differ by an angle of rotation of approximately 90°. However, other solutions are also possible here.

The actuator 5 preferably has at least one or two, in the illustrative example six, latching projections 28A, 28B. The latching projections 28A, 28B are preferably arranged on an inner side of the actuator 5, in particular the inner side of the wall section of the actuator 5 forming or comprising the outer surface 22.

Preferably, the latching projections 28A, 28B are elongated and/or the latching projections 28A, 28B extend parallel to the axis A.

The latching projections 28A, 28B preferably cooperate with the ribs 24A, 24B and/or the stops 27. In particular, the latching projections 28A, 28B serve to define the first and/or second rotational position and/or to latch and/or fix the actuator 5 in the first and/or second rotational position.

Preferably, two latching projections 28A, 28B are assigned to each pair of ribs 24A, 24B. The ribs 24A, 24B of a pair of ribs are preferably arranged between two latching projections 28A, 28B belonging to each other. This is shown in particular in FIG. 5. In particular, a first latching projection 28A is assigned to each first rib 24A and/or a second latching projection 28B is assigned to each second rib 24B.

The distance between a rib 24A, 24B and the latching projection 28A, 28B assigned to the rib 24A, 24B preferably corresponds approximately to the width of the stops 27, in particular so that the stops 27 can each be arranged between a first rib 24A and a first latching projection 28A or a second rib 24B and the assigned second latching projection 28B, and in particular can be latched there. This is shown, for example, in FIG. 6.

When the actuator 5 is in the first rotational position, the stops 27 are preferably each arranged, in particular clamped and/or latched, between a second rib 24B and the respective assigned second latching projection 28B.

When the actuator 5 is in the second rotational position, the stops 27 are preferably each arranged, in particular clamped and/or latched, between a first rib 24A and the respective assigned second latching projection 28A. For the second rotational position, this is shown in particular in FIG. 6.

By means of the latching projections 28A, 28B, in particular in cooperation with the stops 27 and/or ribs 24A, 24B, therefore, an (improved) latching or snapping-in of the actuator 5 in the first and/or second rotational position is achieved in particular.

The dispensing head 3 is preferably designed to emit an acoustic signal when reaching and/or leaving the second rotational position. The acoustic signal signals in particular the reaching of the second rotational position and thus an unlocking or unblocking of the axial movement of the actuator 5. The acoustic signal is preferably a click or clack or the like.

The dispensing head 3 preferably has a signal device 29 for generating the acoustic signal. The signal device 29 is preferably arranged in one of the recesses 26. Preferably, the signal device 29 extends upwards in a rod-like manner from the bottom of the recess 26 and/or the recess 26 is divided by the signal device 29 into two areas, in particular two gaps 30A, 30B, preferably wherein each of the gaps 30A, 30B is designed to receive a rib 24A, 24B.

The signal device 29 preferably extends parallel to the axis A.

Preferably, the signal device 29A is elastic and/or flexible, in particular such that it is bendable or can be bent by contact with a rib 24A.

The signal device 29 preferably extends upwards beyond the blocking surface 25. In other words, an upper tip or end 29A of the signal device 29 is located above a plane formed by the blocking surface 25 and/or above a plane in which the blocking surface 25 is arranged. In particular, this achieves that when the actuator 5 is rotated from the first rotational position to the second rotational position, a rib 24A of the actuator 5 contacts the signal device 29 or its upper end 29A and, in particular, bends it slightly.

The signal device 29 is preferably designed to be flexible and/or elastic in such a way that it first bends somewhat due to the contact of the rib 24A during the rotation and then snaps back to the initial position before the bending. At this point, in particular, the acoustic signal is generated, in particular by the signal device 29 contacting a rib 24A, 24B when snapping back and thereby generating the acoustic signal.

An actuation or operation of the dispensing head 3 or dispenser 1 takes place in particular as follows:

In the delivery state and/or before the first operation/use, the actuator 5 is preferably arranged in the first rotational position. In particular, the actuator 5 is locked in the first rotational position by means of the stops 27A and the first ribs 24A corresponding thereto and first locking projections 28A.

In the first rotational position, pushing down of the actuator 5 in the direction of the container 2 is preferably blocked, so that no dispensing of the fluid F is possible in the first rotational position.

In order to enable fluid dispensing, the actuator 5 must therefore preferably first be moved from the first rotational position to the second rotational position, in particular rotated about axis A.

Reaching the second rotational position is preferably signaled by an acoustic signal generated by means of the signal device 29 and/or one of the first ribs 24A. Movement beyond the second rotational position is preferably prevented by the first ribs 24A and stops 27, in that the first ribs 24A contact the stops 27 when the second rotational position is reached, thus blocking further movement beyond the second rotational position.

Preferably, the actuator 5 is latched in the second rotational position by means of the first ribs 24A, stops 27 and first latching projections 28A.

In the second rotational position, it is preferably possible to push down the actuator 5, in particular by the ribs 24A, 24B being positioned above the recesses 26.

Fluid is dispensed by actuating the actuator 5 or moving it or pressing it down axially in the direction of the container 2.

When the actuator 5 is pressed down, the piston 7 of the pump is preferably moved or pressed down with the actuator 5. This increases the pressure in the pump chamber 8, which in turn leads to an (automatic) opening of the outlet valve 12, so that the fluid F in the pump chamber 8 is pressurized by the movement of the piston 7 and flows out via the outlet 10 and is finally discharged via an exit channel 31 of the actuator 5.

As the case may be, the actuator 5 must be actuated several times during initial use to first fill the pump chamber 8 with fluid F before fluid is dispensed when the actuator 5 is depressed.

After dispensing the fluid F, the user preferably releases the actuator 5. This is preferably followed by automatic returning of the actuator 5, in particular by means of the return device 13. During returning, the actuator 5 is moved upwards again, and at the same time as the actuator 5, the piston 7 is moved upwards. This creates an underpressure in the pump chamber 8, through which the inlet valve 11 is opened and fluid F is drawn from the container 2 via the inlet 9 into the pump chamber 8.

A further actuation of the dispensing head 3 or dispensing of the fluid F can then take place, or the actuator 5 can be rotated again from the second rotational position back to the first rotational position, in particular in order to block a further or inadvertent actuation of the dispensing head 3.

In particular, a first embodiment of the dispensing head 3 has been described above, which is shown in particular in FIGS. 1 to 7. In the following, a second embodiment of the dispensing head 3 is described, which is shown in particular in FIGS. 8 to 12.

FIGS. 8 and 9 show in a partially cut perspective view and a perspective view a section of the dispensing head 3 according to the second embodiment in the original or delivery state, i.e. with unactuated or undamaged tamper-evident seal 15. In analogous views, FIGS. 10 and 11 show the same section of the dispensing head 3 according to the second embodiment as FIGS. 8 and 9, but with actuated or damaged tamper-evident seal 15.

In FIGS. 8 and 10, parts of the housing part 4 have been cut away for better illustration, so that the interior of the dispensing head 3, in particular the tamper-evident seal 15, is clearly visible. The cut surfaces are shown hatched in FIGS. 8 and 10.

The second embodiment differs from the first embodiment in particular in the configuration of the tamper-evident seal 15 and sections of the actuator 5 that interact with and/or are assigned to the tamper-evident seal 15.

In the following, therefore, primarily aspects are explained by which the second embodiment differs from the first embodiment. The preceding explanations regarding the first embodiment therefore also apply to the second embodiment, insofar as this does not result in any contradictions with the following explanations regarding the second embodiment.

In particular, the second embodiment is also based on the basically same operating principle as the first embodiment, namely an actuation of and/or damage to a tamper-evident seal 15 during a first rotation of the actuator 5 from the first rotational position to the second rotational position, in particular by a force exerted by the actuator 5 on the tamper-evident seal 15 or its main body 16.

In the second embodiment, the tamper-evident seal 15 is preferably also formed integrally or in one piece with the housing part 4. Preferably, the tamper-evident seal 15 is arranged, in particular completely, on the upper edge 20 of the housing part 4.

Preferably, the actuator 5 and the tamper-evident seal 15 are configured such that the actuator 5 presses against the tamper-evident seal 15 or exerts a force on the tamper-evident seal 15 during a first rotation relative to the housing part 4 from the first rotational position to the second rotational position, which causes the tamper-evident seal 15 to be damaged and/or actuated. In particular, in the second embodiment, the force is a force directed in the direction of rotation of the actuator 5.

Also in the second embodiment, the tamper-evident seal 15 preferably has a flexure bearing 18 or an area of reduced material thickness by means of which the tamper-evident seal 15 is connected to the housing part 4, in particular its upper edge 20.

Preferably, the flexure bearing 18 has or forms a joint axis or rotational axis B. In the following, the joint axis or rotational axis B is abbreviated as axis B.

The flexure bearing 18 or the axis B preferably extends at least substantially in the radial direction. In contrast, the axis of rotation of the flexure bearing 18 in the first embodiment preferably runs at least substantially in the tangential direction.

The tamper-evident seal 15 may have, in particular in addition to the flexure bearing 18, at least one breakable connecting arm 17 by means of which the tamper-evident seal 15 or the main body 16 is connected to the housing part 4, in particular the upper edge 20.

However, this is not mandatory. In the illustration in FIGS. 8 to 11, the tamper-evident seal 15 does not have a connecting arm 17.

The connecting arm 17 is preferably arranged on the side of the main body 16 opposite the flexure bearing 18. The connecting arm 17 preferably runs at least substantially in the radial direction.

The (first) rotation of the actuator 5 from the first rotational position to the second rotational position causes in particular the tamper-evident seal 15 to be pivoted or folded down. Particularly preferably, the tamper-evident seal 15 is pivoted or folded down by at least substantially 90°. The pivoting or folding down preferably takes place about the axis B or the flexure bearing 18. The pivoting or folding down by at least substantially 90° is apparent in particular from the comparison of FIGS. 8 and 10.

Particularly preferably, the tamper-evident seal 15 or its main body 16 protrudes inwards and/or downwards from the inner wall of the housing part 4, in particular the upper edge 20.

In the present invention, the term “bottom” refers in particular to the position of the dispensing head 3 or dispenser 1 shown in the figures, in which the axis A is at least substantially vertically oriented and/or the dispensing head 3 is located at the top of the dispenser 1 or container 2.

FIG. 8 shows the tamper-evident seal 15 projecting downwards from the upper edge 20 or the main body 16 projecting downwards. In addition, the tamper-evident seal 15 protruding downwards from the upper edge 20 or its main body 16 also protrudes inwards from the housing part 4 or edge 20.

In principle, however, it is also possible in the second embodiment for the tamper-evident seal 15 or the main body 16 to be arranged on the wall section 19 of the housing part 4 and/or to project inwards from the wall section 19 or housing part 4 in at least a substantially radial direction.

In the second embodiment, the tamper-evident seal 15 is pivoted or folded inwards and/or downwards and/or arranged inside or on an inner side of the housing part 4 and/or dispensing head 3 after the actuator 5 has been damaged or actuated or rotated for the first time. This is shown in particular in FIGS. 10 and 11.

In particular, the tamper-evident seal 15 and/or the main body 16 is flush with the housing part 4, in particular the upper edge 20, in the unactuated state shown in FIGS. 8 and 9. As a result of the actuation, the tamper-evident seal 15 or the main body 16 is preferably pivoted or folded downwards and/or inwards. In particular, this creates a gap in the housing part 4, in particular the upper edge 20, which is easily perceived by the user, as shown in particular in FIGS. 10 and 11. Through this gap, the user can see that the dispensing head 3 has already been used or that a first rotation of the actuator 5 from the first to the second rotational position has already taken place.

The actuator 5 preferably has a driver 32. The driver 32 is preferably assigned to the tamper-evident seal 15 and/or designed to actuate and/or damage the tamper-evident seal 15 or its main body 16, in particular during the first rotation of the actuator 5 from the first to the second rotational position, or to exert a corresponding force, in particular in the direction of rotation, on the tamper-evident seal 15 or the main body 16, by means of which actuation or damage, in particular pivoting or folding down of the tamper-evident seal 15, is effected. In other words, the driver 32 is preferably designed to press against the tamper-evident seal 15 or the main body 16, in particular during the first rotation of the actuator 5 from the first to the second rotational position.

In particular, the driver 32 is arranged on the outside of the actuator 5. The driver 32 is preferably designed and/or arranged to exert a tangential force or a force directed in the direction of rotation of the actuator 5 on the tamper-evident seal 15 or the main body 16 and/or to press against the tamper-evident seal 15 or the main body 16 in the direction of rotation.

Preferably, the driver 32 is formed integrally or in one piece with the actuator 5.

When the actuator 5 is moved for the first time from the first to the second rotational position, the driver 32 preferably comes into contact with the main body 16 of the tamper-evident seal 15, the rotation of the actuator 5 causing the driver 32 to press against the main body 16 and thus to fold down or pivot the latter, in particular downwards and/or inwards, as can be seen from FIGS. 8 and 10. The folding down or pivoting of the main body 16 or of the tamper-evident seal 15 preferably takes place about the axis B and/or the flexure bearing 18.

The dispensing head 3 preferably has a fixing device 33 for fixing the actuated, in particular folded down or pivoted and/or damaged, tamper-evident seal 15 or main body 16. In particular, the housing part 4 has the fixing device 33. The fixing device 33 is preferably designed for automatic fixing of the tamper-evident seal 15.

Particularly preferably, the fixing device 33 is designed for clamping fixing of the tamper-evident seal 15 or main body 16. Very preferably, the fixing device 33 is at least substantially wedge-shaped or V-shaped.

The fixing device 33 is preferably arranged on the inside of the dispensing head 3 or housing part 4, particularly preferably on the underside of the edge 20 and/or wall section 19.

The tamper-evident seal 15 and/or the main body 16 and the fixing device 33 are preferably designed and/or arranged complementary to each other.

In particular, the main body 16 has two arms 16A and/or a recess 16B. The recess 16B is preferably at least substantially V-shaped and/or formed between the arms 16A.

Preferably, the recess 16B is complementary to the fixing device 33.

The tamper-evident seal 15 and the fixing device 33 are preferably designed in such a way that, when the tamper-evident seal 15 or the main body 16 is folded down or pivoted, in particular by means of the driver 32, the main body 16 or its arms 16A and/or recess 16B engage with the fixing device 33, so that the tamper-evident seal 15 or the main body 16 is fixed by means of the fixing device 33, in particular clamped to the fixing device 33.

Individual features and aspects of the present invention can be implemented independently, but also in any combination.

List of reference signs:

| | |
|---|---|
| 1 | Dispenser |
| 2 | Container |
| 3 | Dispensing head |
| 4 | Housing part |
| 5 | Actuator |
| 6 | Pump housing |
| 7 | Piston |
| 8 | Pump chamber |
| 9 | Inlet |
| 10 | Outlet |
| 11 | Inlet valve |
| 12 | Outlet valve |
| 12A | Valve stem |
| 12B | Valve spring |
| 13 | Return device |
| 14 | Mounting part |
| 15 | Tamper-evident seal |
| 16 | Main body |
| 16A | Arm of 16 |
| 16B | Recess of 16 |
| 17 | Connecting arm |
| 18 | Flexure bearing |
| 19 | Wall section |
| 20 | Edge |
| 21 | Outer contour section |
| 22 | Exterior surface |
| 23 | Blocking device |
| 24A | (First) rib |
| 24B | (Second) rib |
| 25 | Blocking surface |
| 26 | Recess |
| 27 | Stop |
| 28A | (First) latching projection |
| 28B | (Second) latching projection |
| 29 | Signal device |
| 29A | Upper end of 29 |
| 30A | Gap |
| 30B | Pap |
| 31 | Exit channel |
| 32 | Driver |
| 33 | Fixing device |
| A | Axis |
| B | Axis |
| F | Fluid |

1. A dispensing head for a dispenser for dispensing a fluid,
wherein the dispensing head comprises a housing part and an actuator rotatable relative to the housing part for actuating the dispensing head and/or dispenser, and
wherein the dispensing head, in particular the housing part, has a tamper-evident seal,
wherein
the actuator and the tamper-evident seal are designed in such a way that, when the actuator is rotated for the first time relative to the housing part from a first rotational position into a second rotational position, the actuator exerts a force on the tamper-evident seal, which causes a damage and/or actuation of the tamper-evident seal, in particular wherein the force is directed in the direction of rotation of the actuator and/or radially outwards, and/or
the tamper-evident seal is formed integrally with the housing part.

2. The dispensing head according to claim 1, wherein the dispensing head and/or the housing part is/are designed in such a way that the tamper-evident seal is formed integrally with the housing part.

3. The dispensing head according to claim 1, wherein the dispensing head and/or the housing part is/are designed in such a way that the tamper-evident seal is connected to the housing part even after the damage and/or actuation by the rotation of the actuator.

4. The dispensing head according to claim 1 wherein the tamper-evident seal has at least one connecting arm via which the tamper-evident seal is connected to the housing part.

5. The dispensing head according to claim 4, wherein the connecting arm is breakable by the rotation of the actuator.

6. The dispensing head according to claim 1, wherein the tamper-evident seal has a flexure bearing or an area of reduced material thickness via which the tamper-evident seal is connected to the housing part.

7. The dispensing head according to claim 1, wherein the tamper-evident seal has a main body.

8. The dispensing head according to claim 1, wherein the tamper-evident seal and/or the main body is connected to the housing part via the flexure bearing.

9. The dispensing head according to claim 1, wherein the tamper-evident seal is arranged, in particular completely, on an upper edge of the housing part.

10. The dispensing head according to claim 1, wherein the tamper-evident seal projects inwards and/or downwards from an inner wall of the housing part.

11. The dispensing head according to claim 1, wherein the tamper-evident seal is pivoted or folded outwards after the damage and/or actuation and/or the first rotation of the actuator.

12. The dispensing head according to claim 1, wherein the tamper-evident seal is pivoted or folded inwards and/or downwards after the damage and/or actuation and/or the first rotation of the actuator.

13. The dispensing head according to claim 1, wherein the tamper-evident seal is pivoted or folded down by the rotation of the actuator, in particular by at least substantially 90° and/or about an axis (B) perpendicular to a central axis (A) of the housing part or dispensing head and/or at least substantially radial.

14. The dispensing head according to claim 1, wherein the dispensing head, in particular the housing part, has a fixing device for fixing the actuated and/or damaged tamper-evident seal.

15. The dispensing head according to claim 14, wherein the fixing device is designed for automatically fixing the actuated and/or damaged tamper-evident seal.

16. The dispensing head according to claim 14, wherein the fixing device is designed for fixing the tamper-evident seal or a main body of the tamper-evident seal by clamping.

17. The dispensing head according to claim 14, wherein the fixing device is arranged on an inner side of the dispensing head or housing part.

18. The dispensing head according to claim 1, wherein the tamper-evident seal, in particular a main body of the tamper-evident seal, has arms and/or a preferably at least substantially V-shaped recess.

19. The dispensing head according to claim 14, wherein the fixing device is designed complementary to the arms and/or the recess.

20. The dispensing head according to claim 14, wherein the arms and/or the recess is/are designed for fixing the tamper-evident seal or main body.

21. The dispensing head according to claim 1, wherein the actuator comprises a driver for exerting the force on the tamper-evident seal and/or for actuating and/or damaging the tamper-evident seal.

22. The dispensing head according to claim 1, wherein the first rotational position an actuation or axial movement of the actuator is blocked and in the second rotational position an actuation or axial movement of the actuator is enabled.

23. The dispensing head according to claim 1, wherein the actuator is rotationally asymmetrical about an axis of rotation and/or has a rotationally asymmetrical outer contour section, in particular wherein the outer contour section runs in the shape of an arc of a circle in a first sector and runs straight in a second sector.

24. The dispensing head according to claim 1, wherein the dispensing head is at least partially arranged in the housing part or is enclosed by the housing part and/or the housing part is of sleeve-like design.

25. The dispensing for dispensing a fluid having a dispensing head according to claim 1.
